(19) United States
(12) Patent Application Publication
(10) Pub. No.: US 2010/0241602 A1
(43) Pub. Date: Sep. 23, 2010

(54) METHOD AND SYSTEM FOR FACILITATING DYNAMIC LEARNING

(76) Inventors: Krishna K. Bhardwaj, New Delhi (IN); Prabish Chandran, Noida (IN); Sandeep S. Nair, Palghat (IN)

Correspondence Address: STRATEGIC PATENTS P.C.., C/O PORTFOLIOIP, P.O. BOX 52050, MINNEAPOLIS, MN, 55402, US

(21) Appl. No.: 12/405,328

(22) Filed: Mar. 17, 2009

(51) Int. Cl. G06N 5/02

(52) U.S. Cl. 706/46

(57) ABSTRACT

The present invention provides methods and systems for facilitating dynamic learning for a user. The methods and systems include assimilating information related to the attributes associated with the user from multiple sources, linking the assimilated information with multiple learning conduits, selecting a subset of the multiple learning conduits based on a predefined criterion, customizing the selected subset of the multiple learning conduits based on the assimilated information, and providing the subset of the multiple learning conduits for facilitating dynamic learning for the user. The assimilated information is embedded into the multiple pre-existing learning conduits.

### FIELD OF INVENTION

The invention herein disclosed generally refers to facilitation of computer-based learning and specifically to dynamic computer-based learning.

### BACKGROUND

Most organizations make use of training as a tool for achieving optimum, quality output in diverse job profiles and functional levels. The training is preceded by identification of the knowledge and skill level of the person to be trained and matching this to the demands or requirements of the job to be performed. In most cases, an employee specific computer-based training is used for this purpose. For example, a new graduate in electrical engineering who is expected to work as a power system engineer would receive the specific training that would facilitate his efficient functioning in the new role.

Identification of the type of training to be imparted is traditionally done through collection of information regarding the individual's particular skills and knowledge level from pre-defined computer-based forms filled by that person. Since every individual may have a different set of professional capability, providing customized training may be a tedious and time-consuming process.

In this context, there exists the need for a system that can identify the type of training to be imparted and customize that training to match individual needs.

### SUMMARY

In embodiments, the present invention provides methods and systems for facilitating dynamic learning for a user. The methods and systems may include assimilating information from multiple sources related to the attributes associated with the user, linking the assimilated information with multiple learning conduits, selecting a subset of the multiple learning conduits based on a predefined criterion, customizing the selected subset of the multiple learning conduits based on the assimilated information, and providing the subset of the multiple learning conduits to the user for facilitating dynamic learning. The assimilated information may be embedded into the multiple, pre-existing learning conduits.

In embodiments, the methods and systems may include sequencing the subset of the multiple, pre-existing learning conduits based on information assimilated from multiple sources. In embodiments, the subset of multiple, pre-existing learning conduits may be sequenced based on the user characteristics and network characteristics associated with the user.

In embodiments, the content associated with the subset of multiple, pre-existing learning conduits may be customized based on the personalized information associated with the user. In embodiments, the subset of multiple, pre-existing learning conduits may be sequentially rendered on the display device in response to user initialization.

In embodiments, the information may be related to the network infrastructure tools associated with the user. In embodiments, the information may be linked using an XML file having information related to a domain associated with the user. In embodiments, the information may be assimilated by probing the user. Probing the user may include starting an iterative interactive session with the user.

In embodiments, linking the assimilated information may include mapping the assimilated information with an index of the plurality of the pre-existing learning conduits.

In embodiments, the multiple, pre-existing learning conduits may be categorized based on the attributes associated with multiple users. In embodiments, the predefined criterion may be based on requirements stated by the user in an interactive session.

In embodiments, methods and systems for facilitating dynamic learning for a user may be provided. The methods and systems may include a repository of multiple, pre-existing learning conduits, an assimilation facility for assimilating information related to the attributes associated with the user, and a processing facility and an output facility for providing the subset of the plurality of pre-existing learning conduits to the user. The repository holding plurality of learning conduits may be a stand-alone database, a distributed database, or a client server database. Furthermore, in the distributed database the learning conduits may be fragmented based on topic, location, user characteristics, and the like. In addition, the repository may include a facility for performing spider searching in order to regularly update or add content. The processing facility includes a linking facility for linking the assimilated information with multiple, pre-existing learning conduits based on the attributes associated with the user, a selection facility for selecting a subset of multiple, pre-existing learning conduits and a customizing facility for dynamically customizing the selected subset of multiple, pre-existing learning conduits based on the attributes associated with the user.

In embodiments, the linking facility of the processing capability further includes a mapping capacity for mapping the assimilated information with an index of the plurality of the pre-existing learning conduits.

In embodiments, the output facility may further include a sequencing facility for sequentially providing the subset of multiple, pre-existing learning conduits. In embodiments, the sequencing facility provides the subset of multiple learning conduits based on user characteristics and network characteristics associated with the user.

In embodiments, the output facility sequentially may render the subset of multiple, pre-existing learning conduits to a displaying facility associated with the user.

In embodiments, a computer program product is provided for facilitating dynamic learning for a user. The computer program product may include a computer usable storage medium having computer-readable program code embodied in the medium executable by a processing unit. The computer-readable program code may include a computer-readable program code having instructions to assimilate information related to the attributes associated with the user from multiple sources, another computer-readable program code having instructions to link the assimilated information with multiple pre-existing learning conduits, and yet another computer-readable program code with instructions to select a subset of the multiple, pre-existing learning conduits based on a predefined criterion. It also includes a computer-readable program code having instructions to customize the selected subset of multiple, pre-existing learning conduits based on the assimilated information and a computer-readable program code with instructions to provide the subset of multiple, pre-existing learning conduits for facilitating dynamic learning for the user. The assimilated information may be embedded into multiple, pre-existing learning conduits.

In embodiments, the computer-readable program code with instructions to provide the subset of multiple learning conduits includes instructions to sequence the subset of multiple, pre-existing learning conduits.

In embodiments, the computer-readable program code having instructions to link the assimilated information further includes instructions to map the assimilated information with an index of the plurality of the pre-existing learning conduits.

### BRIEF DESCRIPTION OF FIGURES

The features of the present invention, which are believed to be novel, are set forth with particularity in the appended claims. The invention may best be understood with reference to the following descriptions, taken in conjunction with the accompanying drawings, wherein:

FIG. 1 illustrates a system for facilitating dynamic learning for a user in accordance with an embodiment of the present invention; and

FIG. 2 illustrates a method for facilitating dynamic learning for a user in accordance with an embodiment of the present invention.

Those with ordinary skill in the art will appreciate that the elements in the figures are illustrated for simplicity and clarity, and they are not necessarily drawn to scale. For example, the dimensions of some of the elements in the figures may be exaggerated, in relation to other elements, in order to improve the understanding of the present invention.

### DETAILED DESCRIPTION

While the specification concludes with the claims defining the features of the invention that are regarded as novel, it is believed that the invention will be better understood from a consideration of the following description in conjunction with the drawings and figures, in which like reference numerals are carried forward.

As required, detailed embodiments of the present invention are disclosed herein; however, it is to be understood that the disclosed embodiments are merely exemplary of the invention and can be embodied in various forms. Therefore, specific structural and functional details disclosed herein are not to be interpreted as limiting but merely as a basis for the claims and as a representative basis for teaching purposes by one skilled in the art that will variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having”, as used herein, are defined as comprising (i.e. open transition). The term “coupled” or “operatively coupled”, as used herein, is defined as connected, although not necessarily directly and not necessarily mechanically.

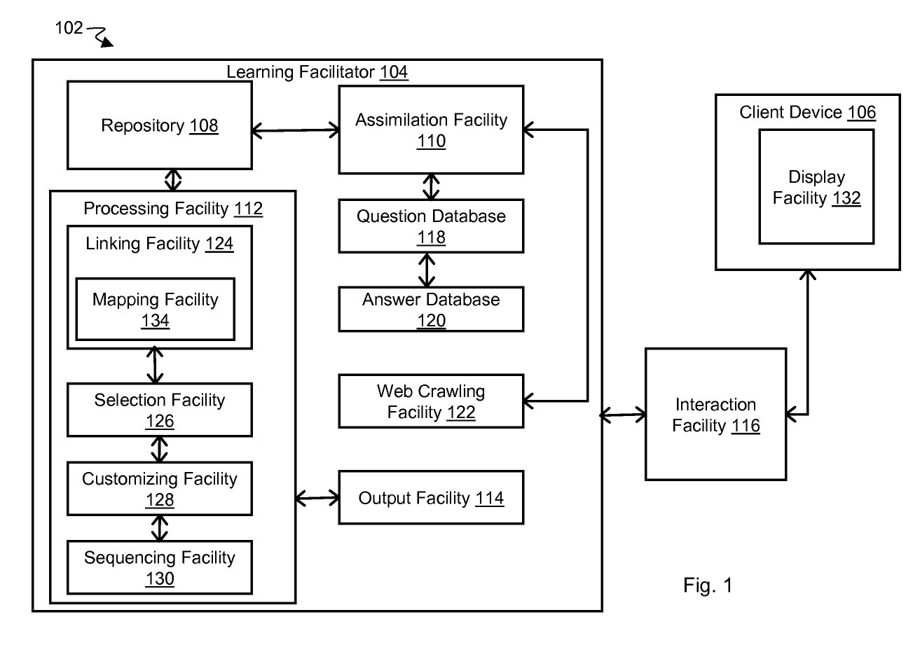

FIG. 1 illustrates a system 102 for facilitating dynamic learning for a user in accordance with an embodiment of the present invention. The system 102 may include a learning facilitator 104 and a client device 106. The learning facilitator 104 provides learning content to the client device 106. Examples of the client device 106 include, but are not limited to a computer, a lap-top, a Personal Digital Assistant (PDA), and a mobile phone. A user (not shown in FIG. 1) may be associated with the client device 106. The system 102 may be implemented in an organization Z, where a user, referred to as employee Y in the examples, may be provided learning content by the learning facilitator 104. The system 102 may be embedded in the internal storage or attachable portable storage media of the client device 106 and may be downloaded or embedded when the user requests the learning.

It should be noted that the system 102 is shown to facilitate only one user associated with the client device 106. However, those skilled in the art would appreciate that the system 102 may facilitate multiple users associated with corresponding multiple client devices. For example, the learning facilitator 104 may facilitate dynamic learning simultaneously for multiple users. In embodiments, the client device 106 may be connected with a local area network. In the example given above, the client device 106 associated with the employee Y may also be connected to the local area network of organization Z. In addition, the system 102 is shown to be implemented in an organization; however those skilled in art would appreciate that the system 102 can be implemented in any other appropriate environment.

In embodiments, the client device 106 may be a stand-alone device or it may be in a distributed architecture. In addition, the client device 106 may be located in any geographical location. In the given example, organization Z may be located in any geographical location. The client device 106 located in one location (A) of organization Z may access information present on a server of the organization in another location (B). In embodiments, the client device 106 may communicate with the server with or without wired connections. In embodiments, the client device 106 may be connected with different computer networks based on the network topology. Examples of various network topologies include, but are not limited to, a bus network, a star network, a ring network, a mesh network, a star-bus network, a tree or hierarchical topology network, or some other type of topology. In embodiments, the client device 106 may be connected with a Personal Area Network (PAN), Campus Area Network (CAN), Metropolitan Area Network (MAN), Wide Area Network (WAN), Global Area Network (GAN), and the like.

The learning facilitator 104 may include a repository 108, an assimilation facility 110, a processing facility 112, and an output facility 114. The repository 108 may include a plurality of pre-existing learning conduits (hereinafter called learning conduits). The learning conduits may be defined herein for the purpose of this invention as logically related content arranged in a way that may facilitate the learning of a subject addressed in the conduit. The learning conduits may also be defined as a group of logically related learning conduits related to a single subject. Further, the definition of learning conduits is not limited as described herein, and it may further include all the definitions, synonyms, antonyms, and any other descriptions as known to those ordinarily skilled in the art. The learning conduits may contain content related to diversified domains. Continuing with the above stated example, the learning conduits for organization Z may include the content or training material corresponding to the mobile communication domain. The learning conduits for organization Z may also include various policies, contracts, and data-sheets.

In embodiments, the learning conduits may be organized based on the attributes associated with multiple users. For example, the learning conduits in the example of organization Z may be arranged based on personal attributes such as designation, age, gender, or some other characteristic of its employees. For example, the learning conduits may be organized based on a designation such as “engineer”, “senior engineer”, or “team lead”. In embodiments, the learning conduits may also be organized based on the technological domains of the personnel. For example, the learning conduits for organization Z may be organized based on a technological domain, namely “Global System for Mobile Communication” and/or “Code Division Multiple Access”. In one scenario, these technological domains may be further categorized into sub-domains. In another scenario, the learning conduits may be organized by combining the attributes associated with multiple users, technological domains, and some other characteristics.

In embodiments, the learning conduits may be organized based on various database models. Examples of various database models include, but are not limited to, the hierarchical model, the network model, and the relational model. In the hierarchical model, learning conduits may be organized into an inverted tree-like structure implying a multiple, downward link in each node to describe the nesting. This structure may organize the various learning conduits in a hierarchy and may help to establish logical relationships among data elements of multiple files. In the network model, each learning conduit may have multiple parents; i.e., the relationships among learning conduits may be many-to-many. These associations may be tracked via pointers, such as node numbers. In the relational model, information about each learning conduit may be represented in columns and rows. The columns and rows may enumerate the various attributes of the learning conduits. In embodiments, the learning conduits may be indexed.

In embodiments, content of the learning conduits may be in various formats, including JPEG format, GIF format, QuickTime format, and text file format. For example, content related to static photographic images may be stored in a JPEG format, a GIF format, and the like. In embodiments, content of the learning conduits may be in the text file format. The text file format may store the content which has text in a format such as ASCII or UTF-8. Some file formats, such as HTML or the source code of some particular programming language, may also be used to store the content of learning conduits.

In embodiments, metadata of the learning conduits may also be present in the repository 108. For example, data related to the modification/creation of a particular learning conduit may be stored in the repository 108. In embodiments, the metadata may be structural/control metadata, guide metadata, descriptive metadata, administrative metadata, and the like. Structural metadata may help to describe the structure of learning conduits such as tables, columns, and indexes. Guide metadata may help the user to find specific items and is usually expressed as a set of keywords in a natural language.

The repository 108 may be linked with the assimilation facility 110. The assimilation facility 110 may assimilate the information related to the attributes associated with the client device 106 from a plurality of sources. In embodiments, the information of the client device 106 may include the characteristics of the user associated with the client device 106. Examples of the characteristics include, but are not limited to, personal attributes such as designation, age, gender or some other characteristic. For example, the assimilation facility 110 may assimilate or collect the designation and the relevant work-experience of the employee Y. This information may be collected by probing employee Y by means of an iterative interactive session through the client device 106.

In embodiments, the employee Y may be involved in an iterative interactive session with the assimilation facility 110 through an interaction facility 116. In one scenario, employee Y may be presented with the question, “What is your designation in the organization?” After getting the response, employee Y may be presented with another question, “What is your total relevant work experience in the mobile communication domain?” Accordingly, a series of interactive questions/answers may start and the assimilation facility 110 may collect the information related to the characteristics associated with the employee Y. In embodiments, the user, such as employee Y, of the client device 106 may be presented the questions from a question database 118. Accordingly, an answer database 120 may collect the answers provided by the user. In embodiments, the question database 118 may present a set series of successive questions based on the user's responses to the previous set of questions in the series. In embodiments, the questions in the question database 118 may be updated from time to time or after a fixed time interval. In one embodiment, the questions in the question database 118 may be updated via web connection. In embodiments, updating of questions in the question database 118 may be achieved by executing an executable file having an updated version of the questions. In embodiments, the question database 118 and the answer database 120 may be a part of the repository 108. In embodiments, the question database 118 and the answer database 120 may be a part of a geographically distributed database.

In embodiments, the assimilation facility 110 may assimilate the user characteristics based on a web-based form. In the above stated example, employee Y of organization Z may be provided with a web-based form that may require the employee Y to fill relevant details. In embodiments, the assimilation facility 110 may also assimilate information related to the network infrastructure associated with the client device 106. Examples of the type of infrastructure information collected include, but are not limited to, the name of the client device 106, the server associated with the client device 106, the IP address associated with the client device 106, the domain name of the client device 106, the number of users connected with the network, the user name, the configuration files, the version, and the format of the files on the client device 106, the environment supported by the client device 106, the hardware attributes associated with the client device 106, and the number of network interface cards, repeaters, hubs, and switches connected to the client device 106.

The assimilation facility 110 may collect the network infrastructure information by using a plurality of tools. The tools include software enabled for collecting network information; hardware device with software, routers, servers, and agents configured for collecting network information; or some other type of devices. In embodiments, information related to the user characteristics and the network characteristics may be directly imported to the assimilation facility 110. For example, information related to employee Y's attributes may be imported from the server of the human resource department of organization Z, and information related to the client device of employee Y may be imported from the IT department of organization Z.

In addition, a web crawling facility 122 may collect information related to the user and the network characteristics. In embodiments, the network characteristics may be stored in a file, a database, and the like. In embodiments, an XML file may store the network characteristics in a tree structure. In embodiments, the network characteristics may be assimilated from the network infrastructure and may be stored in an XML file. The XML file may include details such as number of users, roles, privileges, and some other information associated with each user.

In embodiments, the assimilation facility 110 may assimilate the information associated with the characteristics of the client device 106 as well as the network characteristics associated with the client device 106. For example, the characteristics of employee Y as well as the attributes of the network infrastructure associated with an interactive device of employee Y may be assimilated. In embodiments, the assimilated information related to the user characteristics and/or network characteristics may be stored in the form of a new file or database.

The assimilation facility 110 may be linked with the processing facility 112. The processing facility 112 may include a linking facility 124, a selection facility 126, a customizing facility 128, and a sequencing facility 130. The linking facility 124 may link the assimilated information with the plurality of learning conduits. In embodiments, the linking facility 124 may link the assimilated information with the learning conduits by matching the keywords. In an exemplary scenario, employee Y with an employee code 123 and designation of “senior GSM engineer” may be linked with learning conduits explaining the content of GSM domain. In embodiments, the linking facility 124 may link the assimilated information based on a weighted average of the assimilated information. In an exemplary scenario, employee Y responds to the questionnaire provided by the question database 118. Each answer provided by the employee Y may be given a weighted score. Based on the weighted score of each answer, an average weighted score may be calculated for the employee Y's responses. This average weighted score may be used to link the assimilated information with learning conduits.

In embodiments, the linking facility 124 may link the assimilated information with the learning conduits based on a pre-defined criterion. In embodiments, the predefined criterion may be based on the attributes associated with the user. As explained earlier, the associated attributes include, but are not limited to, personal attributes such as designation, age, gender, or some other characteristic. In embodiments, the predefined criterion may be based on the network infrastructure associated with the client device 106 of the user. In embodiments, the predefined criterion may be based on the combination of attributes as well as the network infrastructure associated with the user. In embodiments, a mapping facility 134 of the linking facility 124 may map the assimilated information with an index of the learning conduits. The mapping facility 134 may be fed with the predefined criterion. In embodiments, the predefined criterion may be fed by an administrator. In embodiments, the linking facility 124 may embed at least a part of the assimilated information in the learning conduits. In embodiments, the information may be linked using an XML file that has information related to a domain associated with the user.

In embodiments, the mapping facility 134 may include a learning algorithm. The learning algorithm may utilize statistical association of content, neural network, and artificial intelligence for accurately organizing assimilated information with plurality of learning conduits.

In embodiments, the linking facility 124 may facilitate the association of the network characteristics, the user characteristics, and the like, with learning conduits. Furthermore, once the association is established between the learning conduits and the network characteristics, the user characteristics, and the like, the linking facility 124 may, in conjunction with the selection facility 126, provide identification of the relevant content to be inserted into the learning conduits.

In embodiments, the linking facility 124 may link the assimilated information using a rule-based association. For example, a rule set may be generated based on the assimilated information. In embodiments, the rule set may be generated automatically by the linking facility 124. In embodiments, the rule set may be generated by an administrator of the learning facilitator 104. In embodiments, the linking facility 124 may link the assimilated information by using fuzzy association. The non-numeric linguistic variables of the fuzzy association may be generated by the linking facility 124 and may be used to facilitate the expression of rules and facts that link the assimilated information with the learning conduits. In embodiments, the linking facility 124 may link the assimilated information using an artificial intelligence-based association.

In embodiments, the linking facility 124 may include an inference facility (not shown in the FIG. 1). The inference facility may link the assimilated information with the learning conduits when the nature of association is not clear. In an exemplary scenario, the answer provided by the employee to the question, “What is your total relevant work experience in mobile communication domain?” can be “two years in GSM”. Now the inference facility may deduce this answer to be “two years in mobile communication domain”. In embodiments, the inference facility may use a synonym facility, a dictionary facility, or other similar facilities. In addition, the inference facility may use pre-existing databases to infer the meaning of the answers provided by the user. In embodiments, the web may be searched to infer the association between the answer provided by the user and the inference facility, if the inference facility is unable to resolve the association. These inferences may enable the linking of the assimilated information with the learning conduits.

The selection facility 126 may select a subset of the linked learning conduits based on a predefined criterion. As explained, the predefined criterion may be based on the assimilated information. The assimilated information includes, but is not limited to, user attributes as well as the network infrastructures associated with the client device 106. In embodiments, the selection facility 126 may select a subset of the linked learning conduits based on attributes associated with the user, such as knowledge of the user, profile of the user, designation of the user, and identification of previously learned content by the user. In an exemplary scenario, the content of learning conduits can be “basics of GSM,” “hand-off in GSM,” “Architectural design for implementing GSM,” and “Troubleshooting for GSM.” The employee Y may be provided with the question, “What is your designation?” to select the subset of the linked conduits. The employee Y's answer to it can be, “GSM engineer”. Again, the employee Y may be provided with a question, “What is your total work-experience in GSM communication?” The employee Y's answer to it can be, “One year”. As employee Y has one year of work experience, the following subsets of the learning conduits may be selected, namely “hand-off in GSM” and “Architectural design for implementing GSM”. The subset “basics of GSM” may not be selected as it will be assumed that employee Y with one year of work-experience would know the basics of GSM. In addition, the subset “Troubleshooting for GSM” may not be selected because it will be assumed that employee Y would not be able to understand the troubleshooting aspects. Extending this scenario, in the initial interaction, employee Y may be provided with some elementary questions related to GSM communication. Based on the answers provided by employee Y, the selection facility 126 may select the subset of the learning conduits. In embodiments, the selection facility 126 may select a subset of the linked learning conduits based on the keyword mapping of the answers provided by the user in the interactive sessions. The keyword mapping may be performed by the mapping facility 134.

In embodiments, the selection facility 126 may select the learning conduits based on the designation of the user. In an exemplary scenario, a client device associated with a GSM engineer may be provided access to a limited number of learning conduits, say “basics of GSM” and “hand-off in GSM;” whereas, the client device associated with the GSM senior engineer may be provided access to “basics of GSM,” “hand-off in GSM,” and “Architectural design for implementing GSM.” This access may be assigned by the organization and may be stored in a server. In embodiments, the level of access, as defined in the server, may facilitate the selection of the learning conduits. In embodiments, a dynamic linking between the learning conduit and the user characteristics and/or network characteristics may happen at runtime.

Once the selection facility 126 selects the subset of learning conduits, the customizing facility 128 may customize the subset of the learning conduits. In embodiments, the customizing facility 128 may customize the subset of learning conduits based on the assimilated information. As explained, the assimilated information includes, but is not limited to, the user characteristics and the network infrastructure associated with the client device 106. In embodiments, the customizing facility 128 may customize the selected subset of the learning based only on the user characteristics. In an exemplary scenario, the user may be provided with the question, “What is your current location?” The user answer to it can be “P.” Following this, another question can be, “Which is the nearest town to P?” The user answer to it may be “Q.” Based on these user characteristics, the customizing facility 128 will customize the content of the learning conduit “hand-off in GSM.” For example, the pre-existing learning conduit “hand-off in GSM” may have explained the concept by stating, “The call disconnects when the employee B moves from Cambridge to Boston.” This same concept may now be customized to “The call disconnects when employee B moves from P (instead of Cambridge) to Q (instead of Boston).” In embodiments, customizing the learning conduits may include replacing the content of the learning conduits with personalized user characteristics or network characteristics. This customization makes the user easily understand the concepts. In embodiments, the customizing facility 128 may customize the conduits based on the network characteristics. In embodiments, the customizing facility 128 may customize the conduits based on a combination of the user characteristics, the network characteristics, and the information collected through the web crawling facility 122.

It should be noted that the functionality of the customizing facility 128 is explained with the help of an exemplary scenario. However, those skilled in the art would appreciate that the customizing facility 128 may customize the learning conduits based on the assimilated information. The customization facility 128 may customize the learning conduits by embedding/replacing the user characteristics or the network characteristics. In addition, the customization facility 128 is shown to customize only the selected learning conduits. However, those skilled in the art would appreciate that the customization facility 128 may customize the learning conduits as a whole. The customization facility 128 may also customize the learning conduits selected by an administrator of the learning facilitator 104.

In embodiments, the content pieces may be tagged with various metadata in the customization facility 128. The content pieces may be tagged to help in determining their suitability for different learners, their learning goals, and their performance environments. In addition, parts of the content pieces may also be individually tagged to enable customization with specifics of learner's situation by way of full/part replacement. In embodiments, the content pieces may be individually tagged to determine the appropriate selections from available valid variations for parts of content and specifics within the content. For example, an animation, showing a process, may be customized with changes based on the specifics available from the learner's situation. Certain customizations may be contained within a content piece but others may have repository wide manifestations. In other words, the customization could also have a cascading effect on entire learning content presented to a particular learner. The customization may use specific information gathered from the learner and/or learner's environment either by itself or in combination with appropriate selections from a repository of complementary details or specifics.

The customizing facility 128 may provide customized learning conduits to the sequencing facility 130. The sequencing facility 130 may arrange the customized learning conduits sequentially based on the user characteristics. In embodiments, the sequencing facility 130 may arrange the learning conduits based on the network characteristics. The sequencing facility 130 may provide the sequenced learning conduits to the output facility 114.

In embodiments, the sequencing facility 130 may enable sequencing of content based on different criteria, including role and privileges associated with a user, user's experience, and user's qualification, previous learning history associated with a user, user's skill, user's knowledge, and the like. In addition, the sequencing facility 130 may identify the knowledge/skill gathered by the user of a particular learning conduit. In order to determine this, the sequencing facility 130 ascertains the number of correct and incorrect answers. If the number of incorrect answers exceeds the number of correct answers, the sequencing facility 130 may rearrange the sequence of the learning conduits to provide a different set of learning conduits to match the correct skill level of the user. This may allow the system to dynamically adjust itself to the user requirements.

In embodiments, the output facility 114 may provide the learning conduits in various formats, including JPEG format, GIF format, QuickTime format, text file, and the like. For example, content related to static photographic images may be provided in JPEG format, GIF format, and the like. In embodiments, the content of the learning conduits may be provided in text file format. In embodiments, the customizing facility 128 may customize the format of the learning conduits based on the user needs.

The output facility 114 provides the sequenced content to a display facility 132 of the client device 106, and hence, facilitates dynamic learning. Examples of the display facility 132 may include a monitor, an LCD Screen, a Plasma display panels (PDP), an Organic light-emitting diode displays (OLED), a Flat panel display, or some other type of display device.

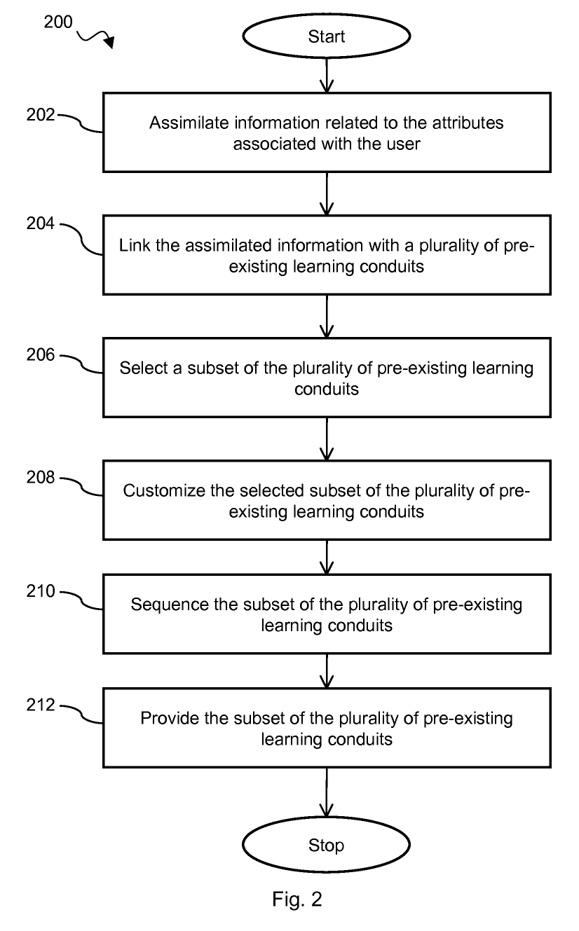

FIG. 2 illustrates a flowchart 200 explaining the method for facilitating dynamic learning for a user according to an embodiment of the present invention. To describe FIG. 2, reference will be made to FIG. 1, although it is understood that the method for facilitating dynamic learning for a user can be practiced in different embodiments. Further, those skilled in the art will appreciate that the method for facilitating dynamic learning for a user may include all or some of the steps shown in FIG. 2. Furthermore, those with ordinary skill in the art will appreciate that the method for facilitating dynamic learning for a user may include additional steps that are not shown in FIG. 2 since they are not germane to the method in accordance with the present invention.

At step 202, information related to the attributes of the user may be assimilated. As explained in the description for FIG. 1, information is related to the user characteristics and network characteristics associated with the user. In embodiments, the assimilation facility 110 in association with the interaction facility 116, web crawling facility 122, question database 118, and answer database 120 may assimilate the information. Following step 202, at step 204, the assimilated information may be linked with the plurality of pre-existing learning conduits. In embodiments, the assimilated information may be embedded in the learning conduits. In embodiments, the linking facility 124 may link the assimilated information with the learning conduits. Following this, at step 206, a subset of the plurality of the learning conduits may be selected based on a predefined criterion. In embodiments, the predefined criterion may be based on the assimilated information. In embodiments, the selection facility 126 in association with the linking facility 124 may select the subsets of the plurality of the learning conduits. At step 208, the selected subsets of the plurality of the learning conduits may be customized based on the assimilated information. In embodiments, the customizing facility 128 may customize the selected subsets of the plurality of the learning conduits.

At step 210, the customized subsets of the plurality of learning conduits may be sequenced based on the user characteristics. In embodiments, the sequencing facility 130 in association with the assimilation facility 110 and the selection facility 126 may arrange the customized subsets of the plurality of learning conduits. At step 212, the customized and sequenced subsets of the plurality of learning conduits may be provided to the user. In embodiments, the output facility 114 may provide the sequenced and customized subset to the display facility 132 of the client device 106.

The invention described above provides customized learning conduits based on user needs. As the customization involves presenting some familiar terms/location/attributes, it makes the user easily understand the concepts stated in the learning conduits. For example, the learning conduits prepared for a US national can be customized for an Indian national, and this would enable the Indian national to understand the concepts easily. In addition, the invention automatically identifies the type of learning conduits to be provided to a user with the help of an interactive session.

It should be noted that the examples in the description are for illustrative purposes only and should not be construed to limit the scope of the invention to such applications. The invention is applicable through its various embodiments in any other environment where training development through personal interaction is facilitated.

It will be appreciated that the above-mentioned method and system for facilitating dynamic learning for a user, described herein, may comprise one or more conventional processors and unique, stored program instructions that control one or more processors to implement some, most, or all of the functions of the system described herein in conjunction with certain non-processor circuits. The non-processor circuits may include, but are not limited to, signal drivers, clock circuits, power source circuits, and user input devices. As such, these functions may be interpreted as steps of a method for facilitating dynamic learning for a user differently. Alternatively, some or all the functions can be implemented by a state machine that has no stored program instructions, or in one or more application-specific integrated circuits (ASICs) in which each function, or some combinations of certain functions, are implemented as custom logic. Of course, a combination of the two approaches can also be used. The methods and means for these functions have been described herein.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

It is expected that one with ordinary skill, notwithstanding possibly significant effort and many design choices motivated by, for example, available time, current technology, and economic considerations; when guided by the concepts and principles disclosed herein, will be readily capable of generating such software instructions, programs, and ICs with minimal experimentation.

In the foregoing specification, the invention and its benefits and advantages have been described with reference to specific embodiments. However, one with ordinary skill in the art will appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims, including any amendments made during the pendency of this application, and all equivalents of those claims, as issued.

All documents referenced herein are hereby incorporated by reference.

What is claimed is:

1. A method for facilitating dynamic learning for a user, the method comprising:
assimilating information related to the attributes associated with the user from a plurality of sources;
linking the assimilated information with a plurality of pre-existing learning conduits, wherein the assimilated information is embedded into the plurality of pre-existing learning conduits based on a predefined criterion;
selecting a subset of the plurality of pre-existing learning conduits based on the predefined criterion;
customizing the selected subset of the plurality of pre-existing learning conduits based on the assimilated information, and
providing the customized subset of the plurality of pre-existing learning conduits for facilitating dynamic learning for the user.

2. The method of claim 1, wherein providing the customized subset comprises sequencing the subset of the plurality of pre-existing learning conduits based on the information assimilated from the plurality of sources.

3. The method of claim 2, wherein sequencing the subset of the plurality of pre-existing learning conduits is based on the user characteristics.

4. The method of claim 2, wherein sequencing the subset of the plurality of pre-existing learning conduits is based on the network characteristics associated with the user.

5. The method of claim 1, wherein customizing the selected subset of the plurality of pre-existing learning conduits comprises replacing the content by personalized information for the user.

6. The method of claim 1, wherein assimilating the information comprises probing the network for information related to the network attributes.

7. The method of claim 1, wherein assimilating the information comprises scanning an XML file for determining a plurality of network parameters, wherein the plurality of network parameters are stored in the XML file.

8. The method of claim 1, wherein assimilating the information comprises probing the user.

9. The method of claim 8, wherein probing the user comprises starting an iterative interactive session with the user.

10. The method of claim 1, wherein linking the assimilated information comprises mapping the assimilated information with an index of the plurality of pre-existing learning conduits.

11. The method of claim 1, wherein the plurality of pre-existing learning conduits is categorized based on the attributes associated with a plurality of users.

12. The method of claim 1, wherein the predefined criteria is based on requirements stated by the user in an interactive session.

13. A system for facilitating dynamic learning for a user, the system comprising:
a repository comprising a plurality of pre-existing learning conduits;
an assimilation facility for assimilating information related to the attributes associated with the user; and
a processing facility, wherein the processing facility including a linking facility for linking the assimilated information with the plurality of pre-existing learning conduits based on a predefined criterion; a selection facility for selecting a subset of the plurality of pre-existing learning conduits; a customizing facility for dynamically customizing the selected subset of the plurality of pre-existing learning conduits based on the attributes associated with the user; and an output facility for providing the subset of the plurality of pre-existing learning conduits to the user.

14. The system of claim 13, wherein the linking facility further comprises a mapping facility for mapping the assimilated information with an index of the plurality of the pre-existing learning conduits.

15. The system of claim 13, wherein the output facility further comprises a sequencing facility for sequentially providing the subset of the plurality of pre-existing learning conduits.

16. The system of claim 15, wherein the linking facility of the processing facility further comprises an inference facility for associating the attributes associated with the user with the learning conduits when the association between the attributes associated with the user with the learning conduits cannot be classified based on the predefined criterion.

17. The system of claim 13, wherein the output facility sequentially renders the subset of the plurality of pre-existing learning conduits to a displaying facility associated with the user.

18. A computer program product for facilitating dynamic learning to a user, the computer program product comprising a computer usable storage medium having computer-readable program code embodied in the medium executable by a processing unit, the computer-readable program code comprising:
computer-readable program code having instructions to assimilate information related to the attributes associated with the user from a plurality of sources;
computer-readable program code having instructions to link the assimilated information with a plurality of pre-existing learning conduits, wherein the assimilated information is embedded into the plurality of pre-existing learning conduits;
computer-readable program code having instructions to select a subset of the plurality of pre-existing learning conduits based on a predefined criterion;
computer-readable program code having instructions to customize the selected subset of the plurality of the pre-existing learning conduits based on the assimilated information, and
computer-readable program code having instructions to provide the subset of the plurality of pre-existing learning conduits for facilitating dynamic learning for the user.

19. The computer program product of claim 18, wherein computer-readable program code having instructions to provide the subset of the plurality of pre-existing learning conduits comprises instructions to sequence the subset of the plurality of pre-existing learning conduits.

20. The computer program product of claim 18, wherein computer-readable program code having instructions to link the assimilated information further comprises instructions to map the assimilated information with an index of the plurality of the pre-existing learning conduits.
